(19) United States
(12) Patent Application Publication
(10) Pub. No.: US 2009/0222863 A1
(43) Pub. Date: Sep. 3, 2009

(54) Wireless video and audio broadcasting device

(76) Inventor: Chung-Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,695

(22) Filed: Sep. 23, 2008

(30) Foreign Application Priority Data
Feb. 29, 2008 (TW) 097107196

(51) Int. Cl. H04N 7/18

(52) U.S. Cl. 725/81

(57) ABSTRACT

A broadcasting device includes a video and audio transmitter, several video and audio receivers to wirelessly receive signals from the video and audio transmitter, and a remote control; the video and audio transmitter is connected to a computer/multimedia broadcasting device; the video and audio receivers are each connected to a respective broadcasting device so that video and audio information from the computer/multimedia broadcasting device can be transmitted through the transmitter, received with the receivers, and broadcasted through the broadcasting devices connected to the receivers; the remote control is used to give orders to the transmitter and the receivers so as to control video and audio information broadcasted through the broadcasting devices; the transmitter has a wireless signal communication module, and can be connected to internet to serve as a router with signals being received and transmitted through the wireless signal communication module.

### BACKGROUND OF THE INVENTION

1. Field of the Invention

The present invention relates to a wireless video and audio broadcasting device, more particularly one, which allows video and audio signals of a computer/multimedia broadcasting device to be wirelessly transmitted to and broadcasted through other broadcasting devices in different rooms, e.g. televisions, overhead projectors, stereos, and speakers; the broadcasting devices have larger screens and higher image and sound quality so that the viewers and listeners can have more enjoyment; the video and audio broadcasting device includes a video and audio transmitter, which and can be connected to internet to serve as a router with signals being received and transmitted through a wireless signal communication module thereof.

2. Brief Description of the Prior Art

Plain televisions and digitalized contents are the major members of the pioneering team in the era of digital homes. Digital contents from other devices can't be broadcasted through a plain television if the plain television isn't digitalized. Modern wireless local area signal communication technology, e.g. Bluetooth (RTM), iPod (RTM), and wifi (RTM) makes it possible for all kinds of home electric appliances to be remote-controlled.

Personal computers have become a necessity of modern life, which can store and broadcast digital video and audio files, handle many things, and allow people to search for information on the World Wide Web, and share video and audio information on various video and audio sharing sites.

And, a wide variety of electronic devices are available for broadcasting multimedia video and audio signals such as films, images, and music besides computers. However, the following problems are found in using the above-mentioned electronic devices:

1. Computers are usually positioned in a study of a house, and used with a screen that has a relatively small size as compared with televisions in a parlor and video/audio room. Therefore, people are prone to have eyestrain after continuing watching a film on the computer screen a certain length of time. In addition, the study can't be as comfortable as a parlor or a video/audio room, and usually doesn't have enough seats and space for many persons.

2. When the user is watching a film on the computer/broadcasting device, other people aren't allowed to share the film on other screens or broadcasting devices in different rooms of a house.

Therefore, it is a main object of the present invention to provide a wireless video and audio broadcasting device to overcome the above problems.

### SUMMARY OF THE INVENTION

A wireless video and audio broadcasting device according to an embodiment of the present invention includes a video and audio transmitter, several video and audio receivers to wirelessly receive signals from the video and audio transmitter, and a remote control. The video and audio transmitter is connected to a multimedia broadcasting device such as computers, MP3, MP4, CD and DVD players. The video and audio receivers are each connected to a respective broadcasting device such as televisions, overhead projectors, stereos, and speakers so that video and audio information contained in the multimedia broadcasting device can be transmitted through the video and audio transmitter, received with the video and audio receivers, and broadcasted through the broadcasting devices connected to the receivers. The remote control is used to give orders to the transmitter and the receivers so as to control video and audio information broadcasted through the broadcasting devices. Therefore, people can share a film or music through the separate external broadcasting devices in different rooms, which external broadcasting devices have larger screens and higher image and sound quality than a person computer. Moreover, the video and audio transmitter has a wireless signal communication module, and can be connected to internet to serve as a router with signals being received and transmitted through the wireless signal communication module. The transmitter, the receiver, a broadcasting device, and a webcam together can comprise a security system, wherein the receiver receives video signals taken with and transmitted from the webcam, and the broadcasting device is connected to the receiver to show the images.

### BRIEF DESCRIPTION OF THE DRAWINGS

The present invention will be better understood by referring to the accompanying drawings, wherein:

FIG. 1 is a perspective view of the present invention,

FIG. 2 is a structural block diagram of the present invention,

FIG. 3 is a view of the video and audio transmitter of the present invention,

FIG. 4 is a structural block diagram of an embodiment of a video and audio transmitter of the present invention,

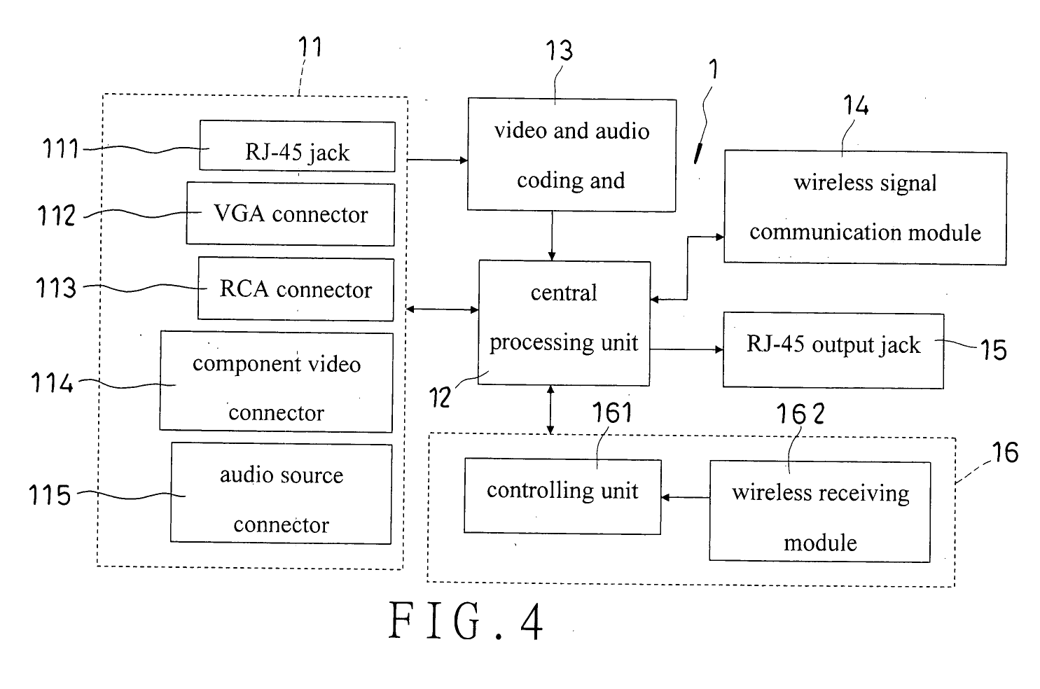

FIG. 5 is a structural block diagram of another embodiment of a video and audio transmitter,

FIG. 6 is a structural block diagram of the video and audio receiver,

FIG. 7 is a structural block diagram of the remote control,

FIG. 8 is a view of the present invention in use (1),

FIG. 9 is a view of the present invention in use (2), and

FIG. 10 is a view of the present invention in use (3).

### DETAILED DESCRIPTION OF THE PREFERRED EMBODIMENTS

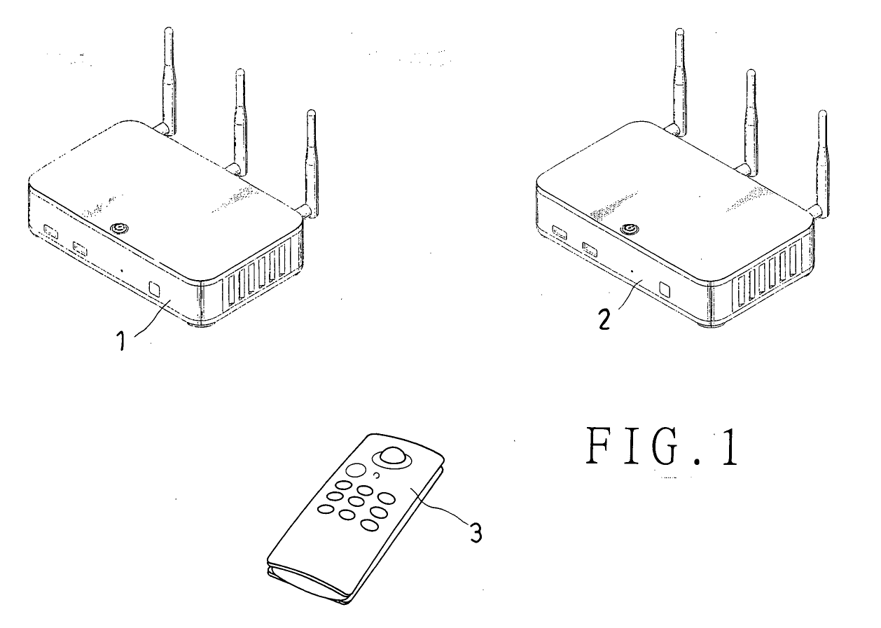

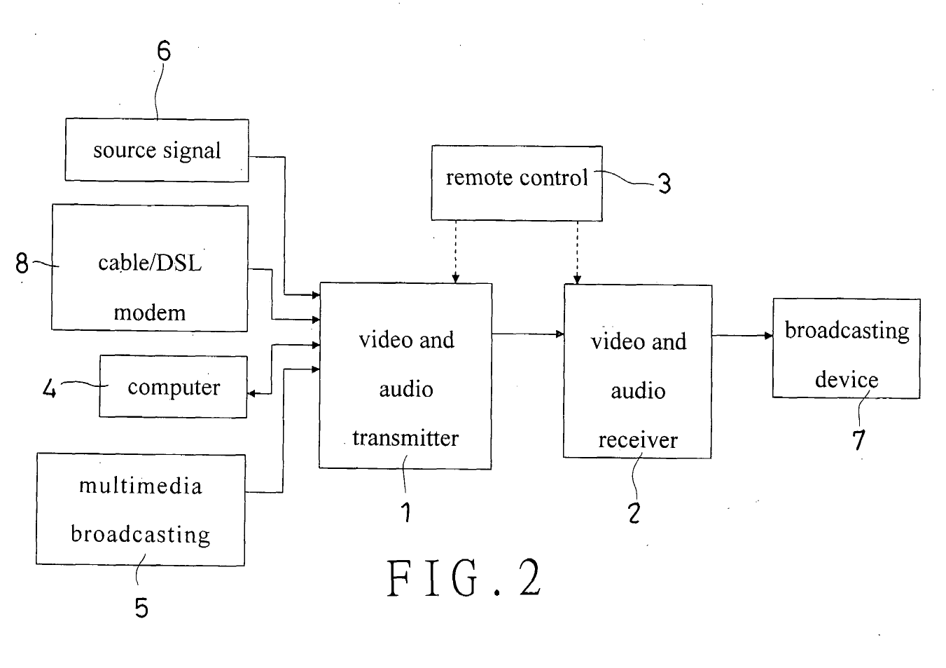

Referring to FIGS. 1 and 2, a preferred embodiment of a wireless video and audio broadcasting device of the present invention consists of a video and audio transmitter 1, a video and audio receiver 2, and a remote control 3.

The video and audio transmitter 1 can be connected to computers 4 or various multimedia broadcasting devices 5 such as CD, DVD, MP3, and MP4 players, and audio source signals 6. The video and audio receiver 2 can be connected to various broadcasting devices 7 such as televisions, overhead projectors, stereos, and speakers. Moreover, the video and audio transmitter 1 can be connected to internet through a cable/DSL modem 8.

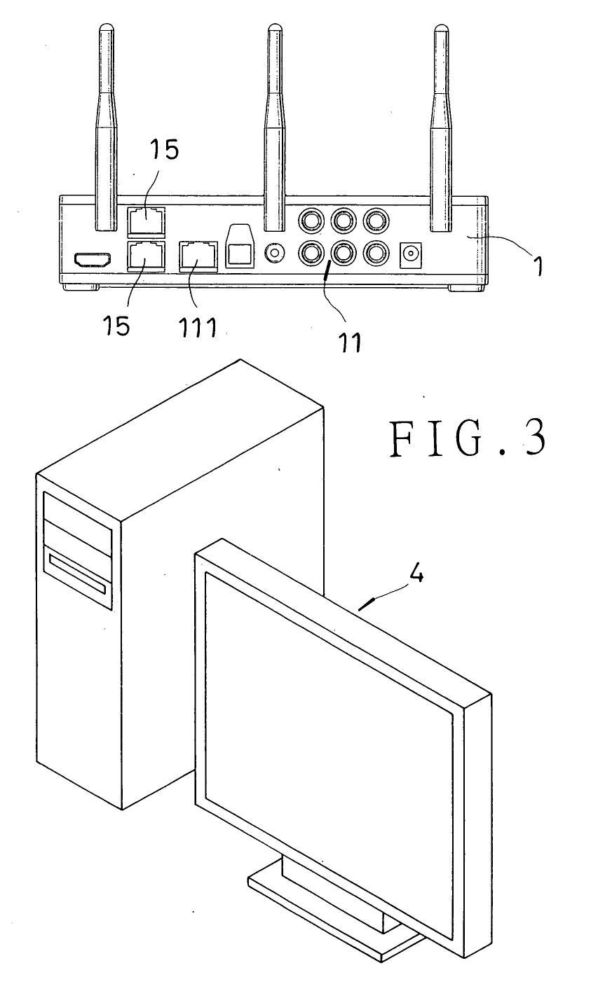

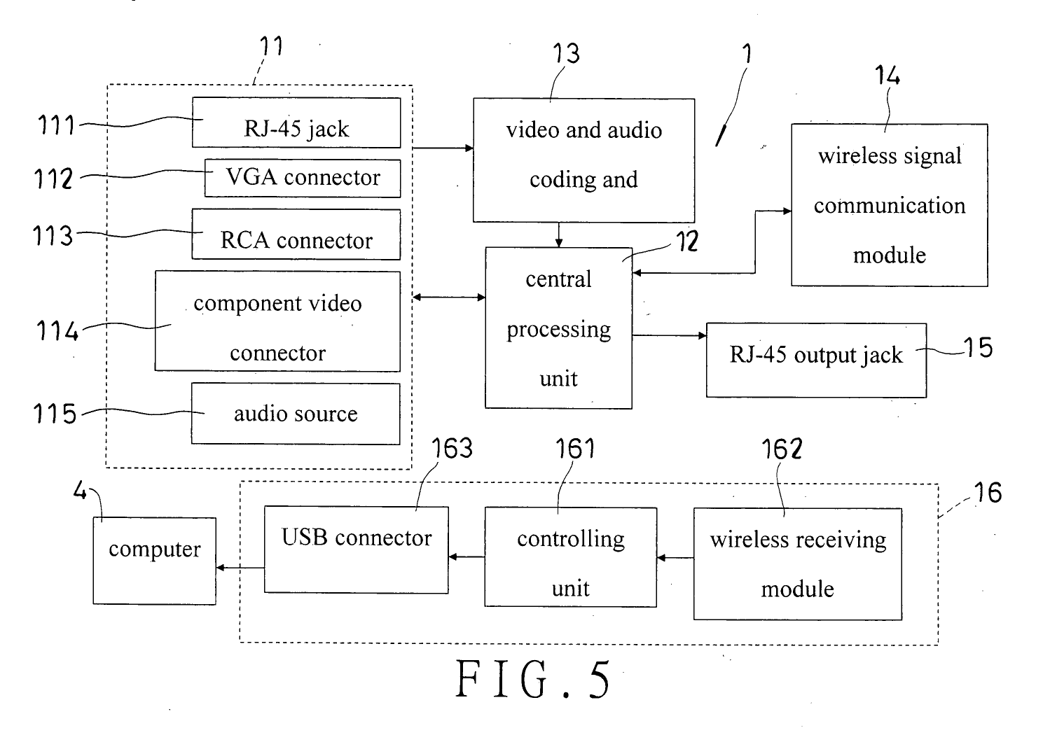

Referring to FIG. 3, a structural block diagram, the video and audio transmitter 1 includes a multiplex interface input unit 11, which can be RJ-45 jacks 111, VGA connectors 112, RCA connectors 113, component video connectors 114, and audio source connectors 115, and which can be connected to computers 4, various multimedia broadcasting devices 5 or cable/DSL modems 8 for inputting video and audio signals such as VGA, DVI, HDMI, and Composite. The video and audio transmitter 1 includes a central processing unit 12, which is connected to the multiplex interface input unit 11. The video and audio transmitter 1 includes a video and audio coding and decoding unit 13, which is connected to the central processing unit 12 as well as the multiplex interface input unit 11. The video and audio transmitter 1 includes a wireless signal communication module 14, which is connected to the central processing unit 12, which can transmit and receive signals of a frequency between 2.4 GHz and 5 GHz in accordance with 802.11n standard. Moreover, a RJ-45 output jack 15 is connected to the central processing unit 12. The video and audio transmitter 1 further includes a built-in receiving module 16, which is used to receive signals from a remote control, and which includes a controlling unit 161, and a wireless receiving module 162; the controlling unit 161 is connected to the central processing unit 12; the wireless receiving module 162 is connected to the controlling unit 161, and can receive radio frequency signals with a frequency of 433 Hz. The remote control receiving module 16 can be directly built in the video and audio transmitter 1. Or alternatively, the receiving module 16 can be independently plugged into a computer; referring to FIG. 5, a structural block diagram of another preferred embodiment of a video and audio transmitter in the invention, the controlling unit 161 of the remote control receiving module 16 has an USB (Universal Serial Bus) connector 163 for connection with an USB port of a computer 4.

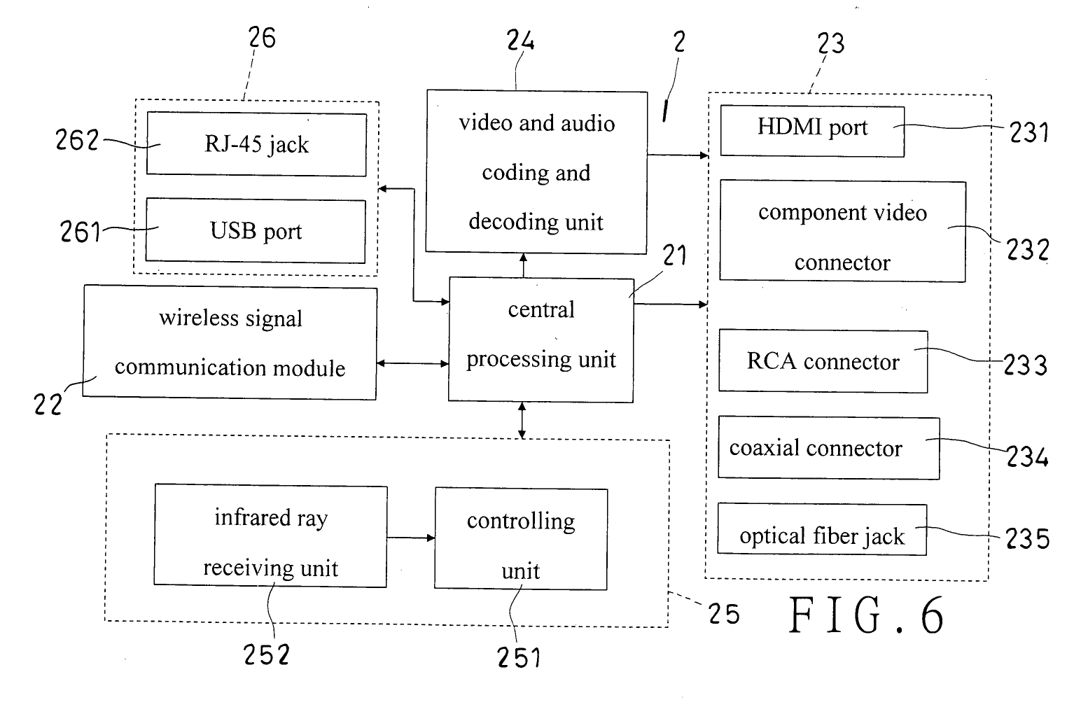

FIG. 6 is a structural block diagram of the video and audio receiver 2; the video and audio receiver 2 includes a central processing unit 21, and a wireless signal communication module 22, which is connected to the central processing unit 21 to receive and transmit signals with a frequency between 2.4 GHz and 5 GHz in accordance with 802.11n standard. The video and audio receiver 2 further includes a video and audio output module 23, and a video and audio coding and decoding unit 24, both of which are connected to the central processing unit 21. The video and audio coding and decoding unit 24 is further connected to the video and audio output module 23. The video and audio output module 23 can be HDMI ports 231, component video connectors 232, RCA connectors 233, coaxial connectors 234 or optical fiber jacks 235, and it can be connected to various broadcasting devices 7 such as televisions, overhead projectors, stereos, and speakers so that video and audio signals can be input through the video and audio output module 23. The video and audio receiver 2 further includes a remote control controlling module 25, which includes a controlling unit 251 connected to the central processing unit 21; the controlling unit 251 is further connected to an infrared ray receiving unit 252 to receive infrared ray signals emitted from the remote control 3. The central processing unit 21 is connected to an external input unit 26 having USB ports 261 and RJ-45 jacks 262 so that other external devices such as hard disks (HD), portable memory cards, and network cables can be connected to the external input unit 26 in order for video and audio signals to be input into the central processing unit 21. Consequently, the video and audio signals are coded and decoded with the video and audio coding and decoding unit 24, and are next sent from the video and audio output module 23 to broadcasting devices 7, e.g. televisions, overhead projectors, stereos, and speakers, through the signal cables; thus, the signals can be broadcasted through the broadcasting devices 7.

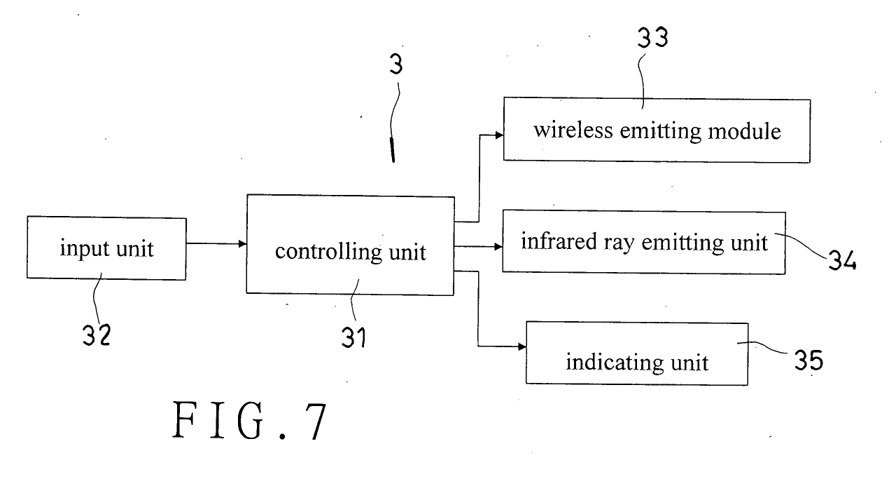

FIG. 7 is a structural block diagram of the remote control 3; the remote control 3 includes a controlling unit 31, and an input unit 32. The input unit 32 is connected to the controlling unit 31. The remote control 3 further includes a wireless emitting module 33, which is connected to the controlling unit 31, and can emit signals with a frequency of 433 Hz to control and operate the video and audio transmitter 1. The remote control 3 further includes an infrared ray emitting unit 34, which is connected to the controlling unit 31 to control and operate the video and audio receiver 2. In addition, an indicating unit 35 is connected to the controlling unit 31, which can emit a beam to serve as a pointer in a briefing, and which can be a laser module.

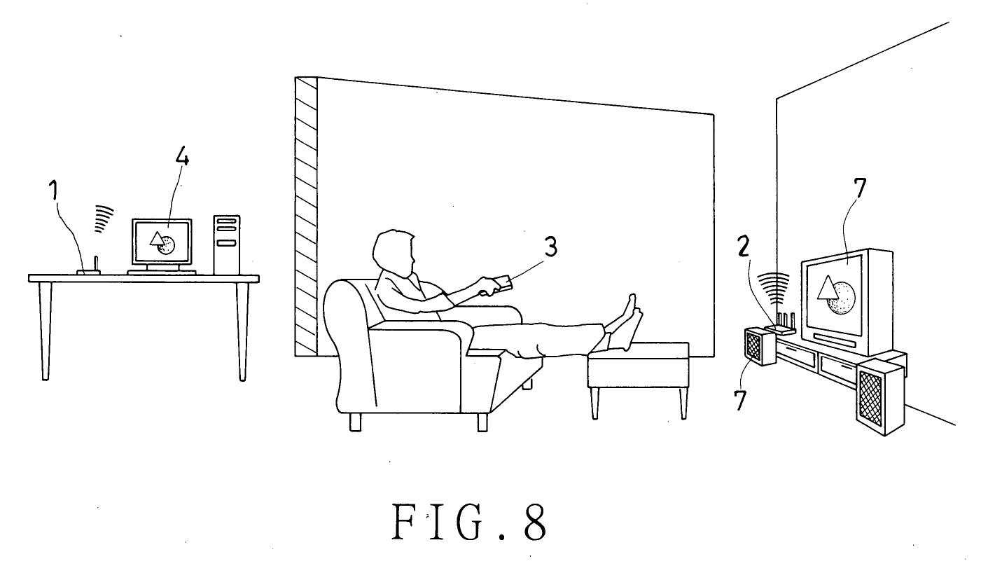

FIG. 8 illustrates a way to use the present wireless video and audio broadcasting device, wherein the video and audio transmitter 1 is connected to a computer 4 in a study, and several such video and audio receivers 2 are respectively connected to various broadcasting devices 7 in a parlor and video/audio rooms of a house, which broadcasting devices 7 can be televisions, overhead projectors, stereos or speakers; in use, the users operates the remote control 3 so that signals are input from chosen signal sources to the central processing unit 12 through the multiplex interface input unit 11. Therefore, the video and audio transmitter 1 will obtain video and audio information from the computer 4 or a multimedia broadcasting device 5 connected thereto or obtain video and audio signals such as Internet Protocol Television (IPTV) signals from internet through the cable/DSL modem 8, and next the video and audio coding and decoding unit 13 will convert analogous signals into digital ones, and the central processing unit 12 will process the digital data, and next the wireless signal communication module 14 will transform the data into signals with a frequency in accordance with 802.11n standard, and emit the signals. Next, the wireless signal communication modules 22 of the video and audio receivers 2 will receive the above signals with a frequency in accordance with 802.11n standard, and the central processing units 21 will process the signals, and the video and audio coding and decoding units 24 will decode the signals so that the digital signals are converted into analogous ones. Next, the analogous signals are sent to the video and audio output modules 23. Therefore, video and audio signals can be broadcasted by various broadcasting devices 7, e.g. televisions, overhead projectors, stereos, and speakers, which are connected to the HDMI ports 231, component video connectors 232, RCA connectors 233, coaxial connectors 234, and optical fiber jacks 235 of the video and audio output modules 23; thus, people can share the video and audio signals on different broadcasting devices at the same time. Therefore, the viewers can view a movie on broadcasting devices 7 with large screens and high image and sound quality instead of an equivalent device used with the computer 4 distant from the various broadcasting devices 7; the viewers will have more pleasure in seeing a movie on the broadcasting devices 7 because the broadcasting devices 7 have large screens and high image and sound quality. Moreover, the user is allowed to operate the remote control 3 through the input unit 32 so that the infrared ray receiving unit 252 of the video and audio receiver 2 receives signals emitted from the infrared ray emitting unit 34 of the remote control 3, and the video and audio signals are broadcasted in a way according to the orders given to the video and audio receiver 2 through the remote control 3.

Furthermore, when the video and audio transmitter 1 is connected to a computer 4 for one to play computer game, the user can control the computer 4 by means of the input unit 32 of the remote control 3; in operating the input unit 32, the wireless emitting module 33 of the remote control 3 will send out signals with a frequency of 433 Hz, and the remote control receiving module 16 of the video and audio transmitter 1 will receive the signals, and in turn the central processing unit 12 will send the signals to the computer 4; thus, the computer 4 is controlled by means of the remote control 3.

If the remote control receiving module 16 is independently connected to an USB port of a computer 4 through the USB connector 163, the user can control the computer 4 by means of the input unit 32 of the remote control 3, in operating the input unit 32, the wireless emitting module 33 of the remote control 3 will send out signals with a frequency of 433 Hz, and the remote control receiving module 16 will receive the signals; thus, the computer 4 is controlled by means of the remote control 3.

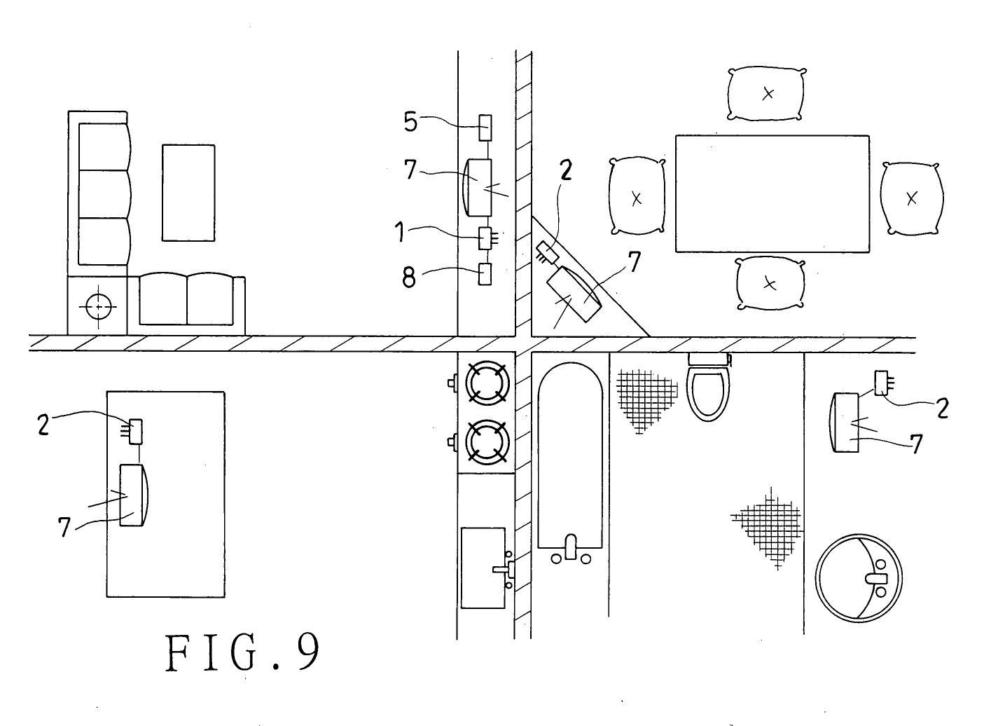

FIG. 9 illustrates another way to use the present wireless video and audio broadcasting device, wherein the video and audio transmitter 1 is connected to a multimedia broadcasting device 5, e.g. VCD and DVD players, and several such video and audio receivers 2 are respectively connected to broadcasting devices 7 positioned in different rooms; a film and music in the multimedia broadcasting device 5 will be wirelessly sent out through the video and audio transmitter 1, and the video and audio receivers 2 will receive the film and music for the broadcasting device 7 to broadcast the film and music. Therefore, people won't miss the film and music even if they have to stay in the different rooms to carry out their respective activities. Furthermore, if the RJ-45 jack 111 of the video and audio transmitter 1 is connected to internet through a cable and a cable/DSL modem 8, and connected to the signal cable of Internet Protocol Television (IPTV), a chosen film and music from IPTV will be wirelessly sent out through the video and audio transmitter 1 so that the video and audio receivers 2 can receive the film and music, and the broadcasting device 7 can broadcast the film and music for people to watch and listen to in different rooms at the same time.

Moreover, the video and audio receiver 2 can be used independently of the video and audio transmitter 1; the video and audio output module 23 of the video and audio receiver 2 is connected to a broadcasting device 7 with signal cables, and is connected to a video and audio data containing/transferring device at the external input unit 26 equipped with USB ports 261 as well as RJ-45 jacks 262, video and audio data from the data containing/transferring device can be processed with the central processing unit 21 and the video and audio coding and decoding unit 24 of the video and audio receiver 2, and next broadcasted through the broadcasting device 7. And, the user can control the video and audio data connected to the external input unit 26 by means of the infrared ray emitting unit 34 of the remote control 3.

Furthermore, the video and audio transmitter 1 can be connected to internet through the RJ-45 jack 111 of the multiplex interface input unit 11 and a cable; thus, the video and audio transmitter 1 can serve as a router with signals being received and transmitted through the wireless signal communication module 14 thereof; thus, nearby computers can have access to internet by wireless signal transmission through the video and audio transmitter 1. Furthermore, other such video and audio transmitters 1 or video and audio receivers 2 can be positioned within transmission range of the first video and audio transmitter 1 to comprise a local area network. In addition, when the video and audio transmitter 1 is connected to internet through the RJ-45 jack 111 of the multiplex interface input unit 11 and a cable, and a computer is connected to one of the RJ-45 jacks 15, video and audio signals can be transmitted from the transmitter 1 and received by several video and audio receivers 2, and at the same time the computer can have access to internet through the video and audio transmitter 1.

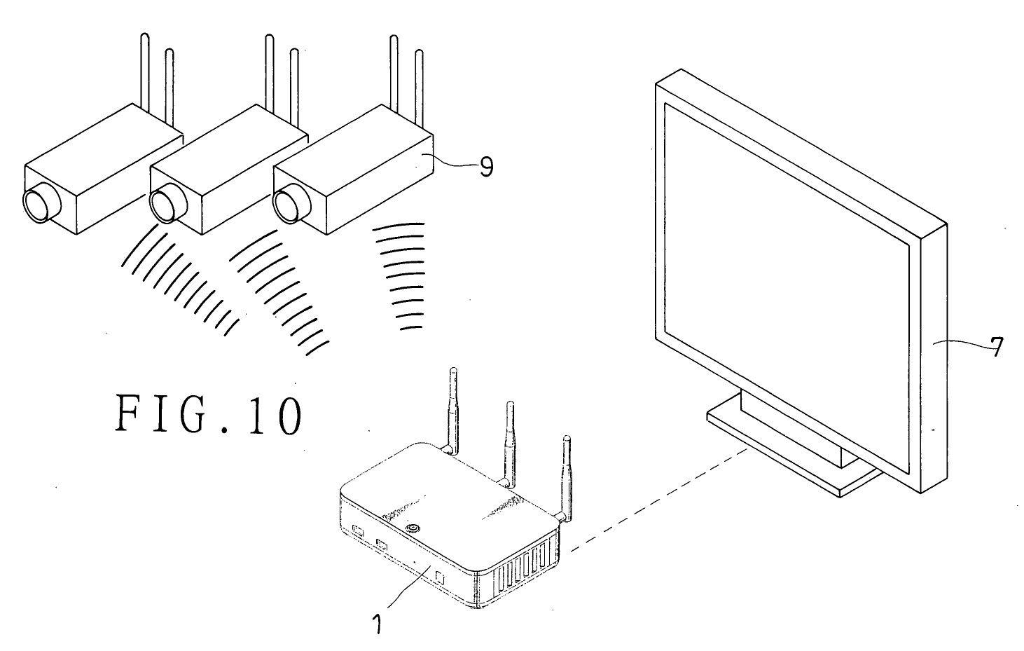

FIG. 10 illustrates another way to use the present video and audio broadcasting device, wherein the wireless signal communication module 14 of the video and audio transmitter 1 receives video signals taken with and transmitted from a webcam 9, and a broadcasting device 7 connected to the video and audio transmitter 2 shows the video images taken with the webcam 9, thus allowing the users to monitor a distant site with the help of the webcam 9, the video and audio transmitter 1, and the broadcasting device 7. And, should unusual situations such as unauthorized entry are detected through the webcam 9, the messages will be packaged with the central processing unit 12 of the transmitter 1, and sent to the users' cellular phones through the RJ-45 jack 111, the cable connected to the RJ-45 jack 111, internet, and the telecommunication stations; thus, the above combination can serve as a wireless digital security system.

From the above description, it can be seen that the present invention has the following advantages over the prior art:

1. Video and audio signals from a computer can be broadcasted through a broadcasting device separate from the computer if the video and audio transmitter of the present invention is connected to the computer to wirelessly transmit the video and audio signals, and the video and audio receiver is connected to the broadcasting device to wirelessly receive the signals for the broadcasting device; the broadcasting device has a large screen and high image and sound quality, and in turn the viewers will have more pleasure in watching a film or listening to music on the broadcasting device.

2. Video and audio information from a multimedia broadcasting device can be broadcasted through several broadcasting devices, which are placed separate from the multimedia broadcasting device in different rooms, if the video and audio transmitter of the invention is connected to the multimedia broadcasting device, and several such video and audio receivers are connected to the broadcasting devices respectively. Therefore, it is unnecessary to install signal cables between the multimedia broadcasting device and each of the different broadcasting devices, and the present invention can provide much convenience.

3. Various devices such as computers, multimedia broadcasting devices, and network cables can be connected to the video and audio transmitter through the multiplex interface input unit so that the user can have more choices of video and audio signal sources. Therefore, the present invention is very practical.

4. Video and audio signals from Internet Protocol Television (IPTV) can be broadcasted through several broadcasting devices at the same time, which are placed in different rooms, if the video and audio transmitter is connected to the IPTV, and several such video and audio receivers are connected to the broadcasting devices respectively. Therefore, the present invention is convenient to use.

5. The video and audio receiver of the present invention is equipped with an external input unit having USB ports and RJ-45 jacks. Therefore, a broadcasting device can be connected to the video and audio receiver, and another external device can be connected to the external input unit for video and audio data in the external device to be broadcasted through the broadcasting device. And, the user can control the video and audio data connected to the external input unit by means of the remote control. Therefore, the present invention is very practical.

6. The video and audio transmitter/receivers of the present invention can be connected to internet through cable/DSL modems so as to obtain video and audio data from internet. Or alternatively, the video and audio transmitter/receivers can obtain video and audio signals from other broadband routers, video and audio sharing devices, IP sharers or wireless stations. Therefore, the video and audio signals can be broadcasted through various broadcasting devices connected to the video and audio receivers.

7. The video and audio transmitter/receivers can be connected to internet through cable/DSL modems to serve as a router so that nearby computers can have access to internet through the video and audio transmitter/receivers. Furthermore, several video and audio transmitters/receivers can be positioned within their transmission range to form a local area network. Therefore, the present invention is practical.

8. The video and audio transmitter can receive video signals transmitted from a webcam wireless for a broadcasting device connected to the video and audio receiver to show the video images taken with the webcam, thus allowing the users to monitor a distant place with the broadcasting device.

9. The wireless video and audio broadcasting device of the present invention is multifunctional, and can transmit and receive signals wirelessly, and therefore it can be a very practical and convenient device in a digital modern home.

What is claimed is:

1. A wireless video and audio broadcasting device, comprising
(a) a video and audio transmitter, which includes:
a multiplex interface input unit for inputting video and audio signals;
a central processing unit connected to the multiplex interface input unit;
a video and audio coding and decoding unit connected, to the central processing unit; the video and audio coding and decoding unit being connected to the multiplex interface input unit;
a wireless signal communication module connected to the central processing unit;
a built-in receiving module to receive signals from a remote control; the receiving module including a controlling unit, which is connected to the central processing unit; the receiving module including a wireless receiving module connected to the controlling unit;
(b) a video and audio receiver, which includes:
a central processing unit;
a wireless signal communication module connected to the central processing unit;
a video and audio output module connected to the central processing unit for inputting video and audio signals;
a video and audio coding and decoding unit connected to the central processing unit; the video and audio coding and decoding unit being connected to the video and audio output module;
a controlling module to receive signals from a remote control; the controlling module including a controlling unit; the controlling module being connected to the central processing unit at the controlling unit thereof; the controlling module including an infrared ray receiving unit connected to the controlling unit thereof;
(c) a remote control; the remote control including:
a controlling unit;
an input unit connected to the controlling unit;
a wireless emitting module connected to the controlling unit; and
an infrared ray emitting unit connected to the controlling unit.

2. The wireless video and audio broadcasting device as claimed in claim 1, wherein the wireless signal communication modules of the video and audio transmitter and the video and audio receiver are used to transmit and receive signals of a frequency between 2.4 GHz and 5 GHz in accordance with 802.11n standard.

3. The wireless video and audio broadcasting device as claimed in claim 1, wherein the wireless emitting module of the remote control is used to emit radio-frequency signals with a frequency of 433 Hz, and the wireless receiving module of the receiving module of the video and audio transmitter is used to receive radio-frequency signals with a frequency of 433 Hz.

4. The wireless video and audio broadcasting device as claimed in claim 1, wherein the video and audio receiver has an external input unit connected to the central processing unit thereof; the external input unit having a plurality of USB ports.

5. The wireless video and audio broadcasting device as claimed in claim 1, wherein the video and audio receiver has an external input unit connected to the central processing unit thereof; the external input unit having a plurality of RJ-45 jacks.

6. The wireless video and audio broadcasting device as claimed in claim 1, wherein the video and audio transmitter has a plurality of RJ-45 output jacks connected to the central processing unit thereof.

7. A wireless video and audio broadcasting device, comprising
(a) a video and audio transmitter, which includes:
a multiplex interface input unit for inputting video and audio signals;
a central processing unit connected to the multiplex interface input unit;
a video and audio coding and decoding unit connected to the central processing unit; the video and audio coding and decoding unit being connected to the multiplex interface input unit;
a wireless signal communication module connected to the central processing unit;
(b) a video and audio receiver, which includes:
a central processing unit;
a wireless signal communication module connected to the central processing unit;
a video and audio output module connected to the central processing unit for inputting video and audio signals;
a video and audio coding and decoding unit connected to the central processing unit; the video and audio coding and decoding unit being connected to the video and audio output module;
a controlling module to receive signals from a remote control; the controlling module including a controlling unit; the controlling module being connected to the central processing unit at the controlling unit thereof; the controlling module including an infrared ray receiving unit connected to the controlling unit thereof;
(c) a remote control receiving module;
a receiving module to receive signals from a remote control; the receiving module including a controlling unit; the receiving module including a wireless receiving module connected to the controlling unit; the receiving module having an USB connector, which is connected to the controlling unit, and which can be connected to an USB port of a computer.
(d) a remote control, which includes:
a controlling unit;
an input unit connected to the controlling unit;
a wireless emitting module connected to the controlling unit; and
an infrared ray emitting unit connected to the controlling unit.

8. The wireless video and audio broadcasting device as claimed in claim 7, wherein the wireless signal communication modules of the video and audio transmitter and the video and audio receiver are used to transmit and receive signals of a frequency between 2.4 GHz and 5 GHz in accordance with 802.11n standard.

9. The wireless video and audio broadcasting device as claimed in claim 7, wherein the wireless emitting module of the remote control is used to emit radio-frequency signals with a frequency of 433 Hz, and the wireless receiving module of the receiving module of the video and audio transmitter is used to receive radio-frequency signals with a frequency of 433 Hz.

10. The wireless video and audio broadcasting device as claimed in claim 7, wherein the video and audio receiver has an external input unit connected to the central processing unit thereof; the external input unit having a plurality of USB ports.

11. The wireless video and audio broadcasting device as claimed in claim 7, wherein the video and audio receiver has an external input unit connected to the central processing unit thereof; the external input unit having a plurality of RJ-45 jacks.

12. The wireless video and audio broadcasting device as claimed in claim 7, wherein the video and audio transmitter has a plurality of RJ-45 output jacks connected to the central processing unit thereof.
